(19) United States
(12) Patent Application Publication
(10) Pub. No.: US 2025/0236803 A1
(43) Pub. Date: Jul. 24, 2025

(54) PLANT AND PROCESS FOR SEPARATING HYDROGEN FROM NATURAL GAS

(71) Applicants: Alessandro BUGLI, Rimini (IT); Marco GIACINTI BASCHETTI, Rimini (IT)

(72) Inventors: Alessandro BUGLI, Rimini (IT); Marco GIACINTI BASCHETTI, Rimini (IT)

(21) Appl. No.: 18/853,529

(22) PCT Filed: Apr. 7, 2023
(86) PCT No.: PCT/IB2023/053584

§ 371 Date: Oct. 2, 2024

(30) Foreign Application Priority Data
Apr. 8, 2022 (IT) 102022000007049

(51) Int. Cl. C10L 3/10; C01B 3/50; F25J 3/06

(52) U.S. Cl. CPC C10L 3/101; C01B 3/506; F25J 3/061; F25J 3/0655; F25J 3/0695; C01B 2203/046; C01B 2203/1241; C01B 2203/1258

(57) ABSTRACT

A plant and a process for separating hydrogen from natural gas. The plant includes a hydrogen separation module, a heat exchanger, a decompressor, downstream of the heat exchanger and in fluid connection with the heat exchanger through a first outlet duct of the heat exchanger, and a flash separator, downstream of the decompressor and in fluid communication with the decompressor through an outlet duct of the decompressor. The flash separator separates a flow of natural gas with a hydrogen content higher than a predetermined threshold, entering the hydrogen separation module through an inlet duct of the heat exchanger, into a first flow of natural gas containing the excess hydrogen and a second flow of natural gas with a hydrogen content below the predetermined threshold. The flash separator includes an upper outlet and a lower outlet, from which an outlet or recirculation duct extends.

### TECHNICAL FIELD

The present invention refers in general to the technical field of natural gas distribution and transportation networks. More particularly, the present invention concerns a plant and a process for separating hydrogen from natural gas in a natural gas distribution and transportation network, typically a gas pipeline.

### BACKGROUND

Natural gas is, along with oil, the most versatile energy source. Its uses are practically similar to those of oil, compared to which it has the advantage of not requiring special transformations. In addition, compared to oil, natural gas has the additional advantage of a considerably lower environmental impact and this aspect contributes to explaining the increasing weight, worldwide, of natural gas compared to other energy sources.

Natural gas is used in domestic, industrial, thermoelectric field, for example as a fuel in power plants, and for automotive. In particular, in homes, natural gas is used for cooking food, for the production of hot water, for individual and central heating, for air conditioning of rooms and, recently, as a fuel for motor vehicles. On the other hand, industries resort to natural gas not only to heat or cool rooms, but also for numerous other applications that make production processes more efficient and economical.

From a structural point of view, the natural gas industry can be described as a vertically integrated supply chain consisting of several steps, namely procurement, transmission and distribution, through medium and low pressure gas pipelines, which in turn is divided into primary and secondary distribution.

Procurement consists of sourcing, through direct production, if territorially availability, or through import from the producing countries if not, the amount of natural gas necessary to cover the national need.

Transmission includes a range of activities, including transportation, storage and dispatching, which are necessary for the transfer and the effective management of the natural gas flows from the production sites to the consumption sites.

Transportation covers the activity of conveying natural gas through high-pressure gas pipeline networks from the producing countries, from domestic production deposits or from storage fields up to the entry of the distribution networks, to which the various end users are connected. The transportation network is divided into a primary (or backbone) network, relative to the high-pressure transportation of natural gas directly from the production or import sites, and into a secondary network, by which is meant the set of pipes (secondary entries) that, starting from the primary network, reach the various hubs of consumption (urban agglomerations, industrial settlements, etc.). Transportation is functionally linked to the storage activity, which consists of preparing deposits of natural gas, called storages, to adapt the offer to the periodic needs of the market. The dispatching activity is complementary to those of transportation and storage and is carried out in special dispatching hubs, which use remote control systems. These systems collect, process and send in a coordinated way all the information to and from the control nodes of the network and constitute, therefore, the operational brain of the flow management system.

Normally, the terminal step of the natural gas cycle is defined as the supply of natural gas, which in turn is composed by distribution and sale. The distribution step is also distinguished into distribution of natural gas by the transport companies to the industrial and thermoelectric end users as well as to the intermediate users, represented by the civil distribution companies and into distribution by the same distribution companies to the residential users. The former case is the primary distribution, the second one the secondary distribution.

Natural gas is a fossil fuel consisting of a mixture of hydrocarbons, mostly methane, and of other gaseous substances such as carbon dioxide, nitrogen, hydrogen sulphide and, in some cases, helium, radon and krypton. Mixtures containing mainly methane are said to be dry, whereas when hydrocarbons such as propane and butane are also present, they are wet.

The natural gas currently distributed in the Italian networks and, in general, throughout the world contains only traces of hydrogen. However, in recent years it has been proposed to include an increasing percentage of hydrogen coming from renewable sources into the hydrocarbon mixture.

However, the city distribution networks, and some industrial users, are not compatible with hydrogen percentages beyond a certain threshold, so it is necessary to separate or extract the amount of excess hydrogen from the natural gas. The techniques currently used to separate the excess hydrogen from the natural gas involve using separation membranes or an oscillating pressure absorption process or PSA, which consists of recovering hydrogen from the natural gas by injecting the latter into columns containing an absorbing chemical product. Hydrogen does not react with the absorbent and can be later recovered. These techniques, albeit effective, have a significant energy expenditure, as well as high costs and environmental impact.

Document U.S. Pat. No. 2,900,797 A describes a plant and a process for separating carbon dioxide and methane. Document US 2021/317378 A1 describes a plant and a process for separating a “dry” gas from one rich in heavier compounds. Document U.S. Pat. No. 4,163,652 A describes a plant and a process for the fractionation of cracking gases in an ethylene production plant.

### SUMMARY

It is an object of the present invention to overcome the disadvantages of the prior art.

In particular, it is an object of the invention to present a plant and a process for separating hydrogen from natural gas, such as to allow, with a significant energy saving, the separation of excess hydrogen present in a flow of natural gas at the entry, producing at the exit a flow of hydrogen-poor natural gas, suitable for use in a natural gas distribution network.

Another object of the invention is to present a plant for separating hydrogen from natural gas, which is structurally simple and which therefore has reduced construction costs.

These and other objects of the present invention are achieved by a plant and by a process for separating hydrogen from natural gas incorporating the features of the appended claims, which form an integral part of the present disclosure.

In a first aspect thereof, the invention is therefore directed to a plant for separating hydrogen from natural gas comprising a hydrogen separation module, which includes a heat exchanger, decompression means, placed downstream of the heat exchanger and in fluid connection with the heat exchanger through a first outlet duct of the heat exchanger, and a flash separator, placed downstream of the decompression means and in fluid communication with the decompression means through an outlet duct of the decompression means. The flash separator is configured to separate a flow of natural gas with a hydrogen content higher than a predetermined threshold, entering the hydrogen separation module through an inlet duct of the heat exchanger, into a first flow of natural gas containing excess hydrogen and a second flow of natural gas with a hydrogen content below the predetermined threshold. The flash separator comprises an upper outlet and a lower outlet, from which an outlet or recirculation duct extends, in the heat exchanger, of the second flow of natural gas exiting from the flash separator, for a heat exchange with the flow of natural gas entering the hydrogen separation module. The heat exchanger comprises a second outlet duct, from the hydrogen separation module, of the second heated flow of natural gas with a hydrogen content below the predetermined threshold.

Thanks to this combination of features, the plant does not require, for separating the excess hydrogen from the entering natural gas, the aid of any material and/or support, such as for example membranes and/or absorbent media, as in the case of the separation systems according to the prior art. This results in a significant structural simplification of the plant as well as a significant energy saving over the entire life cycle of the plant itself.

In one embodiment, the plant further comprises, upstream of the hydrogen separation module, at least one auxiliary hydrogen separation module, which comprises a heat exchanger, decompression means, placed downstream of the heat exchanger and in fluid communication with the heat exchanger through a first outlet duct, and a flash separator, placed downstream of the decompression means and in fluid communication with the decompression means through an outlet duct of the decompression means. The flash separator comprises an upper outlet and a lower outlet and is configured to separate a flow of natural gas with a hydrogen content higher than a predetermined threshold, entering the auxiliary hydrogen separation module through the heat exchanger, into a first flow of natural gas containing the excess hydrogen and a second flow of natural gas with a hydrogen content below the predetermined threshold. The upper outlet of the flash separator of the auxiliary hydrogen separation module is in fluid communication with the heat exchanger of the hydrogen separation module placed downstream of the inlet duct of the heat exchanger of the hydrogen separation module and the heat exchanger of the hydrogen separation module is in fluid communication with the heat exchanger of the auxiliary hydrogen separation module through its second outlet duct.

In one embodiment, the lower outlet of the flash separator is in fluid communication with the heat exchanger of the hydrogen separation module placed downstream through a lower outlet duct of the flash separator.

In one embodiment, the plant further comprises a mixer, which intercepts the recirculation duct of the hydrogen separation module and the lower outlet duct of the flash separator of the auxiliary hydrogen separation module and is positioned upstream of the heat exchanger of the hydrogen separation module and with it in fluid connection through an outlet duct of the mixer.

In one embodiment, the auxiliary hydrogen separation module further comprises further decompression means and a further heat exchanger placed downstream of the further decompression means and in fluid communication with them through the outlet duct, wherein the further decompression means are in fluid communication with the flash separator of the auxiliary hydrogen separation module through a lower outlet duct of the flash separator and wherein the further heat exchanger is in fluid communication with the flash separator of the auxiliary hydrogen separation module through the upper outlet duct of the flash separator and with the heat exchanger of the hydrogen separation module through the inlet duct of the heat exchanger.

In one embodiment, the further heat exchanger comprises an outlet or recirculation duct, which puts the further heat exchanger in fluid communication with the heat exchanger upstream.

In one embodiment, the plant further comprises a mixer, which intercepts the outlet duct of the further heat exchanger of the auxiliary hydrogen separation module and the second outlet duct of the heat exchanger of the hydrogen separation module and is positioned upstream of the heat exchanger of the auxiliary hydrogen separation module and with it in fluid connection through an outlet duct of the mixer.

In one embodiment, the heat exchanger of the auxiliary hydrogen separation module comprises a second outlet duct of a total heated flow of natural gas with a hydrogen content below the predetermined threshold.

In one embodiment, from the upper outlet of the flash separator of the hydrogen separation module there extends an upper outlet duct of the first flow of hydrogen-rich natural gas separated inside the flash separator.

In one embodiment, the hydrogen separation module comprises a further heat exchanger, positioned between the heat exchanger and the decompression means. The further heat exchanger is in fluid communication with the heat exchanger through the first outlet duct of the heat exchanger and with the decompression means through a first outlet duct. The further heat exchanger is further in fluid communication with the flash separator through the upper outlet duct of the flash separator and further comprises a second outlet duct.

In a second aspect thereof, the invention is directed to a process for separating hydrogen from natural gas comprising the following steps:

(a) feeding a flow of natural gas at the entry to a heat exchanger of a hydrogen separation module of a hydrogen separation plant, the natural gas having a hydrogen content higher than a predetermined threshold;

(b) pre-cooling the flow of natural gas in the heat exchanger;

(c) cooling, in decompression means, the pre-cooled flow of natural gas exiting from the heat exchanger;

(d) separating, in a flash separator, the cooled flow of natural gas exiting from the decompression means into a first flow of natural gas containing the excess hydrogen and into a second flow of natural gas with a hydrogen content below the predetermined threshold;

(e) recirculating the second flow of natural gas exiting from the flash separator in the heat exchanger, in which it acts as a refrigerant fluid for the flow of natural gas entering the heat exchanger; and

(f) producing, at the exit from the heat exchanger, the second heated flow of natural gas with a hydrogen content below the predetermined threshold.

In one embodiment, the process further comprises, upstream of the feeding step (a), the following steps:
(a1) feeding a flow of natural gas at the entry to a heat exchanger of an auxiliary hydrogen separation module of the hydrogen separation plant, the natural gas having a hydrogen content higher than a predetermined threshold;
(b1) pre-cooling the flow of natural gas in the heat exchanger;
(c1) cooling, in decompression means, the pre-cooled flow of natural gas exiting from the heat exchanger;
(d1) separating, in a flash separator, the cooled flow of natural gas exiting from the decompression means into a first flow of natural gas containing the excess hydrogen and into a second flow of natural gas with a hydrogen content below the predetermined threshold;
(e1) feeding the first flow of natural gas containing the excess hydrogen and the second flow of natural gas with a hydrogen content below the predetermined threshold at the entry to the heat exchanger of the hydrogen separation module;
(f1) recirculating a total flow of natural gas with a hydrogen content below the predetermined threshold in the heat exchanger of the auxiliary hydrogen separation module, in which it acts as a refrigerant fluid for the flow of natural gas entering the heat exchanger; and
(g1) producing, at the exit from the heat exchanger of the auxiliary hydrogen separation module, a total heated flow of natural gas with a hydrogen content below the predetermined threshold.

In one embodiment, the total flow of natural gas with a hydrogen content below the predetermined threshold recirculated in the heat exchanger of the auxiliary hydrogen separation module is obtained by mixing the second flow of natural gas with a hydrogen content below the predetermined threshold exiting from the flash separator of the auxiliary hydrogen separation module and from the second flow of natural gas with a hydrogen content below the predetermined threshold exiting from the flash separator of the hydrogen separation module, wherein the total flow of natural gas with a hydrogen content below the predetermined threshold acts as a refrigerant fluid for the flow of natural gas entering the heat exchanger of the auxiliary hydrogen separation module.

In one embodiment, the step of feeding the first flow of natural gas containing the excess hydrogen at the entry to the heat exchanger of the hydrogen separation module coincides with the feeding step (a).

In one embodiment, the process further comprises, downstream of the separation step (d1), the further steps of:
(e2) cooling, in a further heat exchanger of the auxiliary hydrogen separation module, the first flow of natural gas containing the excess hydrogen exiting from the flash separator;
(f2) cooling, in further decompression means of the auxiliary hydrogen separation module, the second flow of natural gas with a hydrogen content below the predetermined threshold exiting from the flash separator;
(g2) feeding the first cooled flow of natural gas containing the excess hydrogen exiting from the further heat exchanger into the heat exchanger of the hydrogen separation module;
(h2) feeding the second cooled flow of natural gas with a hydrogen content below the predetermined threshold at the entry to the further heat exchanger, in which it acts as a refrigerant fluid for the first flow of natural gas containing the excess hydrogen entering the further heat exchanger; and
(i2) recirculating a total flow of natural gas with a hydrogen content below the predetermined threshold in the heat exchanger of the auxiliary hydrogen separation module, in which it acts as a refrigerant fluid for the flow of natural gas entering the heat exchanger, wherein the total flow of natural gas with a hydrogen content below the predetermined threshold is obtained by mixing the second flow of natural gas with a hydrogen content below the predetermined threshold exiting from the further heat exchanger of the auxiliary hydrogen separation module and the second flow of natural gas with a hydrogen content below the predetermined threshold exiting from the heat exchanger of the hydrogen separation module.

In one embodiment, the step of feeding, into the heat exchanger of the hydrogen separation module, the cooled flow of natural gas containing the excess hydrogen exiting from the further heat exchanger of the auxiliary hydrogen separation module coincides with the feeding step (a).

In one embodiment, the process further comprises, downstream of the separation step (d1), the further steps of:
(m1) feeding the first flow of natural gas into a further heat exchanger of the hydrogen separation module, in which it acts as a refrigerant fluid for the flow of natural gas coming from the heat exchanger; and
(n1) feeding, to the decompression means, the first further cooled flow of natural gas exiting from the further heat exchanger.

In one embodiment, the first flow of natural gas containing the excess hydrogen exiting from the flash separator of the hydrogen separation module has a hydrogen content ranging from 45% to 99% and is stored in a high-pressure storage tank or fed to a distribution network.

In one embodiment, the flow of natural gas entering the hydrogen separation plant is a high-pressure gaseous mixture of natural gas, preferably greater than 40 barg.

In one embodiment, the predetermined threshold is less than about 2%.

Further features and purposes of the present invention will appear clearer from the description that follows.

### BRIEF DESCRIPTION OF THE DRAWINGS

The invention will be described below with reference to some examples, provided by way of non-limiting example, and illustrated in the appended drawings. These drawings illustrate different aspects and embodiments of the present invention and reference numerals illustrating structures, components, materials and/or similar elements in different drawings are indicated by similar reference numerals, where appropriate.

FIG. 1 is a schematic view of a plant for separating hydrogen from natural gas according to a first embodiment of the present invention.

FIG. 2 is a schematic view of a plant for separating hydrogen from natural gas in accordance with a second embodiment of the present invention.

FIG. 3 is a schematic view of a plant for separating hydrogen from natural gas according to a third embodiment of the present invention.

FIG. 4 is a schematic view of a plant for separating hydrogen from natural gas according to a fourth embodiment of the present invention.

FIG. 5 is a schematic view of a plant for separating hydrogen from natural gas according to a fifth embodiment of the present invention.

FIG. 6 is a schematic view of a plant for separating hydrogen from natural gas according to a sixth embodiment of the present invention.

### DETAILED DESCRIPTION OF THE EMBODIMENTS

While the invention is susceptible to various modifications and alternative constructions, some embodiments provided for explanatory purposes are described below in detail.

It must in any case be understood that there is no intention to limit the invention to the specific embodiment illustrated, but, on the contrary, the invention intends covering all the modifications, alternative and equivalent constructions that fall within the scope of the invention as defined in the claims.

In the following description, therefore, the use of “e.g.”, “etc.”, “or” indicates non-exclusive alternatives without limitation, unless otherwise indicated; the use of “also” means “including, but not limited to” unless otherwise indicated; the use of “includes/comprises” means “includes/comprises, but not limited to” unless otherwise indicated.

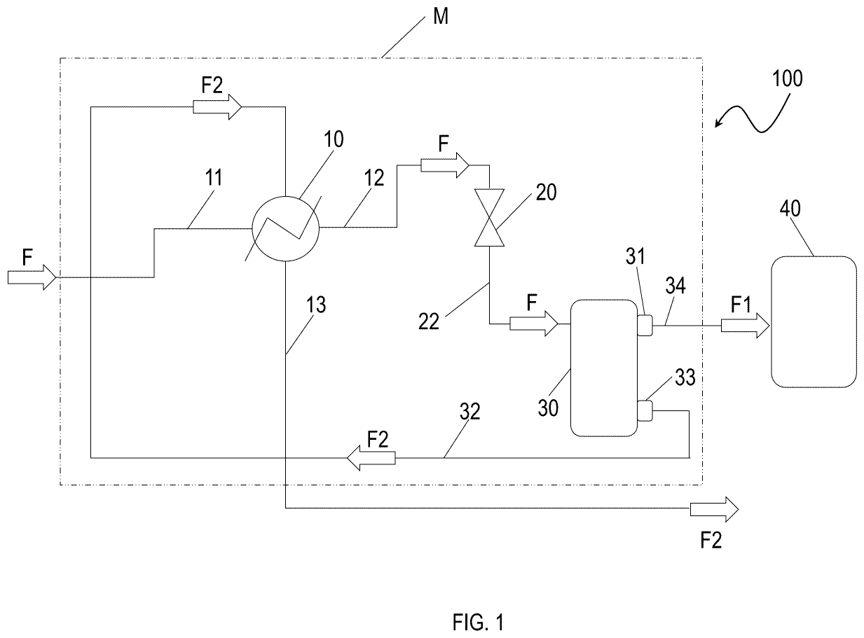

With reference to FIG. 1, a plant for separating hydrogen from natural gas according to a first embodiment of the present invention is illustrated therein.

The plant, generally indicated with the reference numeral 100, comprises a hydrogen separation module M, which comprises a heat exchanger 10, decompression or expansion means 20, placed downstream of the heat exchanger 10 and in fluid communication with the heat exchanger 10 through a first outlet duct 12 of the heat exchanger 10, and a flash separator 30, placed downstream of the decompression means 20 and in fluid communication with the decompression means 20 through an outlet duct 22 of the decompression means 20.

In the plant 100 illustrated in FIG. 1, the decompression or expansion means consist of a throttling valve 20, but alternatively a quasi-isoentropic expander, such as a turboexpander, can be provided. The throttling valve is more reliable than the turbocharger, while the turboexpander is more efficient than the throttling valve.

The flash separator 30 comprises an upper outlet 31, from which an upper outlet duct 34 extends, and a lower outlet 33, from which a lower outlet or recirculation duct 32 extends. The recirculation duct 32 puts the flash separator 30 in fluid communication with the heat exchanger 10 positioned upstream. The heat exchanger 10 further comprises an inlet duct 11 and a second outlet duct 13.

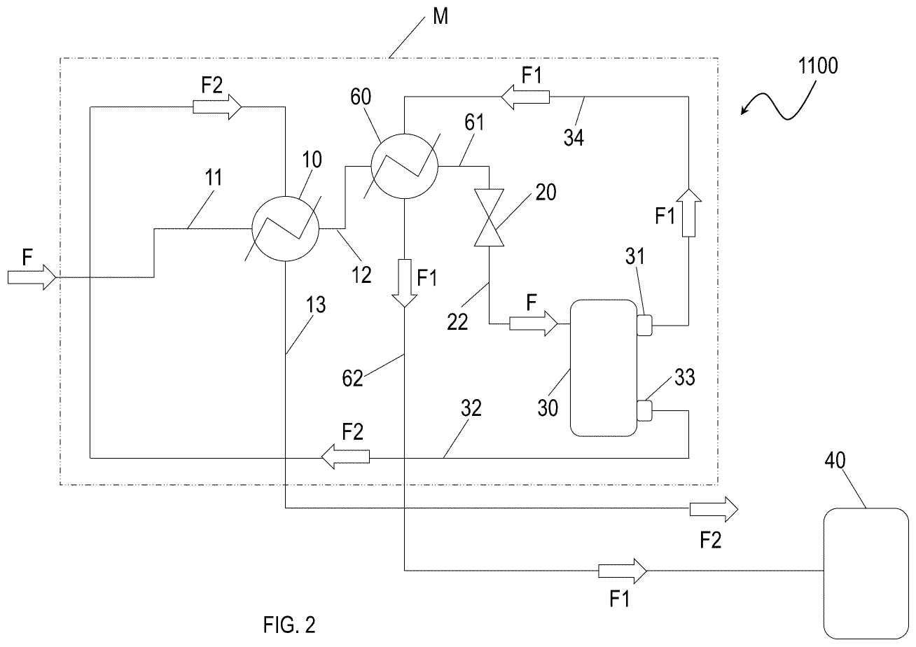

With reference to FIG. 2, a plant for separating hydrogen from natural gas in accordance with a second embodiment of the present invention is illustrated therein.

The plant, generally indicated with the reference numeral 1100, differs from the plant 100 of FIG. 1 in that it provides for a further heat exchanger 60 positioned between the heat exchanger 10 and the throttling valve 20. In particular, the heat exchanger 60 is in fluid communication with the heat exchanger 10 through the first outlet duct 12 of the heat exchanger 10 and with the throttling valve 20 through a first outlet duct 61. The heat exchanger 60 is further in fluid communication with the flash separator 30 through the upper outlet duct 34 of the flash separator and further comprises a second outlet duct 62.

With reference to FIG. 1, a process for separating hydrogen that is carried out using the plant 100 is now described.

When the plant 100 is in operation, a flow F of natural gas, coming from a national distribution network (not shown), for example a methane pipeline, enters the heat exchanger 10 of the hydrogen separation module M of the plant 100 through the inlet duct 11 of the heat exchanger 10 and exits from the heat exchanger 10 through the first outlet duct 12.

The flow F of natural gas entering the plant 100 is a high-pressure gaseous mixture of natural gas, typically greater than 40 barg, with excess hydrogen, i.e. containing a hydrogen percentage higher than a predetermined threshold S, typically equal to about 2%. Preferably the hydrogen content in the entering flow F of natural gas is variable between 4% and 22%, more preferably between 5% and 10%.

Inside the heat exchanger 10, the flow F of natural gas with excess hydrogen undergoes a pre-cooling and the pre-cooled flow F exiting from the heat exchanger 10 enters the throttling valve 20 through the first outlet duct 12.

Inside the throttling valve 20, the pre-cooled flow F of natural gas with excess hydrogen undergoes a decompression or expansion and exits, further cooled, the throttling valve 20 through the outlet duct 22.

Depending on the temperature and pressure conditions of the entering natural gas, the cooled flow F of natural gas with excess hydrogen exits from the throttling valve 20 in the form of a liquid-gas two-phase fluid or of a supercritical fluid and enters the flash separator 30 through the outlet duct 22.

Inside the flash separator 30, the cooled flow F of natural gas with excess hydrogen undergoes a step separation as a result of which it is separated into a first flow F1 of hydrogen-rich natural gas and a second flow F2 of hydrogen-poor natural gas. In particular, the first flow F1 of hydrogen-rich natural gas is in the form of a gaseous mixture containing the excess hydrogen, separated from the entering flow F of natural gas, in a percentage comprised between 45% and 55% and preferably equal to 50%. The second flow F2 of hydrogen-poor natural gas is in the form of a liquid mixture containing a hydrogen percentage lower than the predetermined threshold S, i.e. lower than 1-2% and otherwise entirely equivalent to the flow F of natural gas entering the plant 100 through the inlet duct 11 of the heat exchanger 10.

The first flow F1 of natural gas exits from the flash separator 30 through the upper outlet 31 and the upper outlet duct 34 and is preferably stored in a pressurized tank 40. As an alternative to storage in the pressurized tank 40, the first flow F1 of hydrogen-rich natural gas can be introduced into a distribution network dedicated to industrial users for use, for example, for the production of methane or synthetic hydrocarbons (Sabatier synthesis with use of CO2), or as fuel for some types of fuel cells.

If the further heat exchanger 60 is provided, and therefore the plant 1100 of FIG. 2 is used, the first flow F1 of natural gas exiting from the flash separator 30 through the upper outlet 31 is sent, through the upper outlet duct 34, to the heat exchanger 60. Inside the heat exchanger 60, the flow F of natural gas with excess hydrogen arriving from the exchanger 10 through the first outlet duct 12 is further cooled and introduced into the throttling valve 20 through the first outlet duct 61 of the heat exchanger 60. The first flow F1 exits from the heat exchanger 60 through the second outlet duct 62 and is preferably stored in a pressurized tank 40. As an alternative to storage in the pressurized tank 40, the first flow F1 of hydrogen-rich natural gas can be introduced into a distribution network dedicated to industrial users for use, for example, for the production of methane or synthetic hydrocarbons (Sabatier synthesis with use of CO2), or as fuel for some types of fuel cells.

The second flow F2 of natural gas exits from the flash separator 30 through the lower outlet 33 and is recirculated in the heat exchanger 10 through the recirculation duct 32. The second flow F2 of natural gas, entering the heat exchanger 10 through the recirculation duct 32, acts as a refrigerant fluid of the flow F of natural gas with excess hydrogen, entering the heat exchanger 10 through the inlet duct 11, and exits, heated, from the heat exchanger 10, and from the hydrogen separation module M of the plant 100, through the second outlet duct 13 of the heat exchanger 10.

Following the heat exchange with the flow F of natural gas with excess hydrogen, which takes place inside the heat exchanger 10, the liquid mixture of natural gas, which constitutes the second flow F2 of natural gas, entering the heat exchanger 10 through the recirculation duct 32, evaporates and exits from the plant 100 in the form of a gaseous mixture of natural gas with a hydrogen content lower than the predetermined threshold S lower than 1-2%. The second flow F2 of natural gas exiting from the plant 100 is introduced into the national distribution network at a pressure lower than that of the flow F of natural gas entering the plant and this is made possible thanks to the fact that the natural gas entering the plant is constituted by a high-pressure gaseous mixture.

The separation of the flow F of natural gas entering the first F1 and second flow F2 of natural gas carried out inside the flash separator 30 is made effective by suitably regulating the temperature and pressure conditions of the flow F of natural gas, pre-cooled and cooled, exiting, respectively, the heat exchanger 10 and the throttling valve 20. This is substantially achieved by regulating the amount of the second flow F2 of hydrogen-poor natural gas, exiting from the flash separator 30.

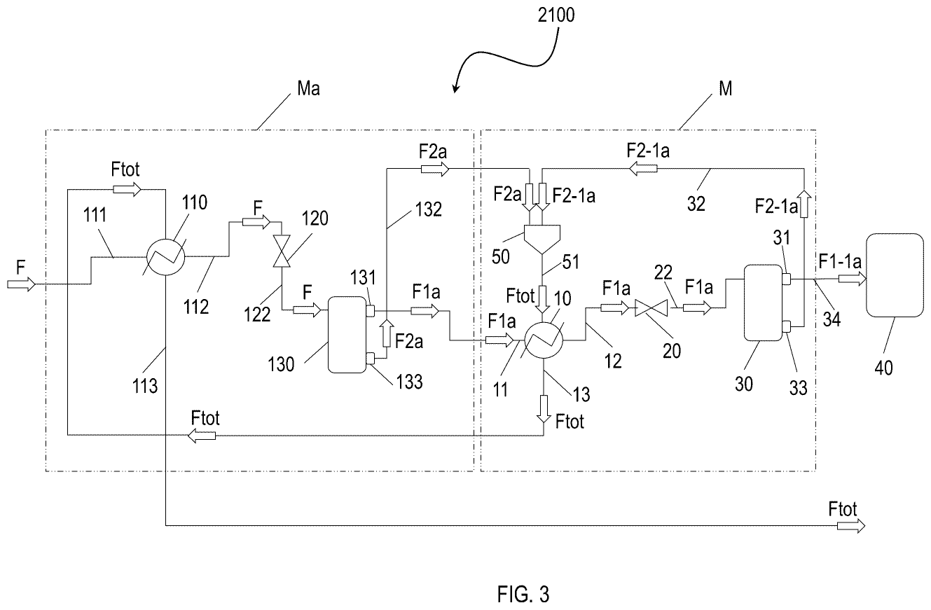

With reference to FIG. 3, a plant for separating hydrogen from natural gas according to a third embodiment of the present invention is illustrated therein. This plant differs from the plants 100 and 1100, described above and illustrated in FIGS. 1 and 2, in that it provides an auxiliary hydrogen separation module, which is positioned upstream of the hydrogen separation module M and with it in fluid connection. The two hydrogen separation modules are then connected in cascade and such a connection increases the separation efficiency, advantageously allowing a hydrogen percentage comprised between 77% and 93% and, more preferably, equal to 85% to be separated from the natural gas entering the plant.

The plant, generally indicated with the reference numeral 2100, therefore comprises, analogously to the plant 100, a hydrogen separation module M, which comprises a heat exchanger 10, decompression or expansion means, for example a throttling valve 20, which are placed downstream of the heat exchanger 10 and in fluid communication with the heat exchanger 10 through a first outlet duct 12 of the heat exchanger 10, and a flash separator 30, placed downstream of the decompression means 20 and in fluid communication with the decompression means 20 through an outlet duct 22 of the decompression means 20.

The flash separator 30 comprises an upper outlet 31, from which an upper outlet duct 34 extends, and a lower outlet 33, from which a lower outlet or recirculation duct 32 extends, which puts the flash separator 30 in fluid communication with the heat exchanger 10 positioned upstream. The heat exchanger 10 further comprises an inlet duct 11 and a second outlet duct 13.

The plant 2100 further comprises, upstream of the hydrogen separation module M, an auxiliary hydrogen separation module Ma, which, analogously to the hydrogen separation module M, comprises a heat exchanger 110, decompression or expansion means, in the illustrated example a throttling valve 120, which are placed downstream of the heat exchanger 110, and a flash separator 130 placed downstream of the throttling valve 120. The throttling valve 120 is in fluid communication with the heat exchanger 110 through a first outlet duct 112 of the heat exchanger 110 and the flash separator 130 is in fluid communication with the throttling valve 120 through an outlet duct 122 of the throttling valve 120.

The flash separator 130 comprises an upper outlet 131 and a lower outlet 134. The upper outlet 131 is in fluid connection with the inlet duct 11 of the heat exchanger 10 of the downstream hydrogen separation module M. A lower outlet duct 132, which puts the flash separator 130 in fluid communication with the heat exchanger 10 of the hydrogen separation module M positioned downstream, extends from the lower outlet 133. The heat exchanger 110 further comprises an inlet duct 111 and a second outlet duct 113.

The plant 2100 further comprises a mixer 50, which intercepts the lower outlet or recirculation duct 32 and the lower outlet duct 132 of the flash separators 30 and 130 and is positioned upstream of the heat exchanger 10 of the hydrogen separation module M and with it in fluid connection through an outlet duct 51.

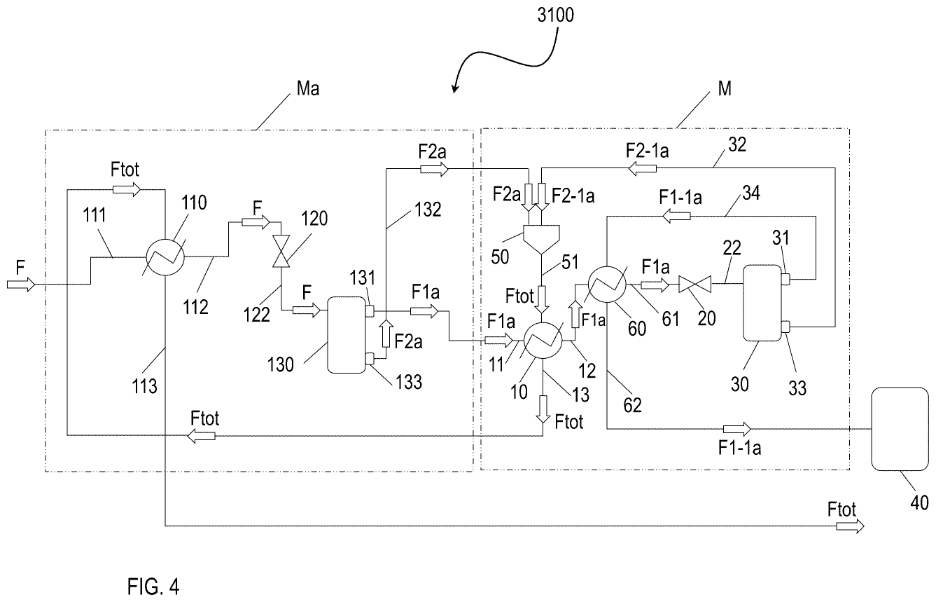

With reference to FIG. 4, a plant for separating hydrogen from natural gas in accordance with a fourth embodiment of the present invention is illustrated therein.

The plant, generally indicated with the reference numeral 3100, differs from the plant 2100 of FIG. 3 in that it provides, in the hydrogen separation module M, a further heat exchanger 60 positioned between the heat exchanger 10 and the throttling valve 20. In particular, the heat exchanger 60 is in fluid communication with the heat exchanger 10 through the first outlet duct 12 of the heat exchanger 10 and with the throttling valve 20 through a first outlet duct 61. The heat exchanger 60 is further in fluid communication with the flash separator 30 through the upper outlet duct 34 of the flash separator and further comprises a second outlet duct 62.

With reference to FIG. 3, a process for separating hydrogen that is carried out using the plant 2100 is now described.

When the plant 2100 is in operation, a flow F of natural gas with excess hydrogen, coming for example from a methane pipeline (not shown), enters the heat exchanger 110 of the auxiliary hydrogen separation module Ma through the inlet duct 111 and exits from the heat exchanger 110 through the first outlet duct 112.

Inside the heat exchanger 110, the flow F of natural gas with excess hydrogen undergoes a pre-cooling and the pre-cooled flow F exiting from the heat exchanger 110 enters the throttling valve 120 through the first outlet duct 112.

Inside the throttling valve 120, the pre-cooled flow F of natural gas with excess hydrogen undergoes a decompression or expansion and exits from the throttling valve 120, further cooled and in the form of a liquid-gas two-phase fluid, through the outlet duct 122. The cooled flow F of natural gas with excess hydrogen exiting from the throttling valve 120 then enters the flash separator 130 through the outlet duct 122 of the throttling valve 120.

Inside the flash separator 130, the cooled flow F of natural gas with excess hydrogen is separated into a first flow F1a of hydrogen-rich natural gas and a second flow F2a of hydrogen-poor natural gas. In particular, the first flow F1a of hydrogen-rich natural gas is in the form of a gaseous mixture of natural gas containing a hydrogen percentage comprised between 45% and 55% and more preferably equal to 50%. The second flow F2a of hydrogen-poor natural gas is in the form of a liquid mixture of natural gas containing the excess hydrogen in a percentage lower than 1-2% and otherwise entirely equivalent to the flow F of natural gas entering the heat exchanger 110 of the auxiliary hydrogen separation module Ma of the plant 1100 through the inlet duct 111 of the heat exchanger 110.

The first flow F1a of natural gas exits from the upper outlet 131 of the flash separator and is fed to the heat exchanger 10 of the hydrogen separation module M placed downstream through the inlet duct 11 of the heat exchanger 10.

Inside the heat exchanger 10, the flow F1a of natural gas undergoes a pre-cooling and enters, pre-cooled, the throttling valve 20 through the first outlet duct 12 of the heat exchanger 10.

Inside the throttling valve 20, the pre-cooled flow F1a of hydrogen-rich natural gas undergoes a decompression or expansion, and exits, further cooled, the throttling valve 20 through the outlet duct 22 in the form of a liquid-gas two-phase fluid or a supercritical fluid.

The cooled flow F1a of natural gas exiting from the throttling valve 20 then enters the flash separator 30 through the outlet duct 22 of the throttling valve 20.

Inside the flash separator 30, the cooled flow F1a of natural gas is separated into a first flow F1-1a of hydrogen-rich natural gas and a second flow

F1-2a of hydrogen-poor natural gas. In particular, the first flow F1-1a of hydrogen-rich natural gas is in the form of a gaseous mixture of natural gas containing a hydrogen percentage comprised between 77% and 93% and more preferably equal to 85%. The second flow F2-1a of hydrogen-poor natural gas is in the form of a liquid mixture of natural gas containing the excess hydrogen in a percentage lower than the predefined threshold S, i.e. lower than 1-2%.

The first flow F1-1a of natural gas exits from the flash separator 30 through the upper outlet 31 and the upper outlet duct 34 and is preferably stored in a pressurized tank 40 or introduced into a distribution network dedicated to industrial users for use, for example, for the production of methane or synthetic hydrocarbons (Sabatier synthesis with use of CO2), or as fuel for some types of fuel cells.

If the further heat exchanger 60 is provided, and therefore the plant 3100 of FIG. 4 is used, the first flow F1-1a of natural gas exiting from the flash separator 30 through the upper outlet 31 is sent, through the upper outlet duct 34, to the heat exchanger 60. Inside the heat exchanger 60, the flow F1a of natural gas with excess hydrogen arriving from the exchanger 10 through the first outlet duct 12 is further cooled and introduced into the throttling valve 20 through the first outlet duct 61 of the heat exchanger 60. The first flow F1-1a exits from the heat exchanger 60 through the second outlet duct 62 and is preferably stored in a pressurized tank 40. As an alternative to storage in the pressurized tank 40, the first flow F1-1a of hydrogen-rich natural gas can be introduced into a distribution network dedicated to industrial users for use, for example, for the production of methane or synthetic hydrocarbons (Sabatier synthesis with use of CO2), or as fuel for some types of fuel cells.

The second flow F2-1a of natural gas exits from the flash separator 30 through the lower outlet 33 and is recirculated in the heat exchanger 10 through the recirculation duct 32, together with the second flow F2a of natural gas exiting from the flash separator 130 of the auxiliary hydrogen separation module Ma through the lower outlet 133 and an outlet duct 132 of the flash separator 130. In particular, the flows F2-1a and F2a are mixed together in the mixer 50 and the resulting total flow Ftot is recirculated in the heat exchanger 10 through the outlet duct 51 of the mixer 50.

The total flow Ftot of natural gas entering the heat exchanger 10 acts as a refrigerant fluid of the flow F1a of natural gas, entering the heat exchanger 10 through the inlet duct 11. Following the heat exchange which takes place inside the heat exchanger 10, the liquid mixture of natural gas, which constitutes the total flow Ftot of natural gas, evaporates and exits from the heat exchanger 10 in the form of a gaseous mixture of natural gas with a hydrogen content lower than 1-2%. The total flow Ftot of natural gas exiting from the heat exchanger 10 is recirculated, through the outlet duct 13 of the heat exchanger 10, in the heat exchanger 110 of the auxiliary hydrogen separation module Ma.

The total flow Ftot of hydrogen-poor natural gas, entering the heat exchanger 110 through the outlet duct 13, acts as a refrigerant fluid of the flow F of natural gas with excess hydrogen, entering the heat exchanger 110 through the inlet duct 111 and exits, heated, from the heat exchanger 110, and from the auxiliary hydrogen separation module Ma of the plant 1100, through the second outlet duct 113 of the heat exchanger 110.

Following heating, the liquid mixture of natural gas, which constitutes the total flow Ftot of natural gas, entering the heat exchanger 110 through the outlet duct 13, evaporates and exits from the plant 1100, through the second outlet duct 113, in the form of a gaseous mixture of natural gas with a hydrogen content lower than 1-2%.

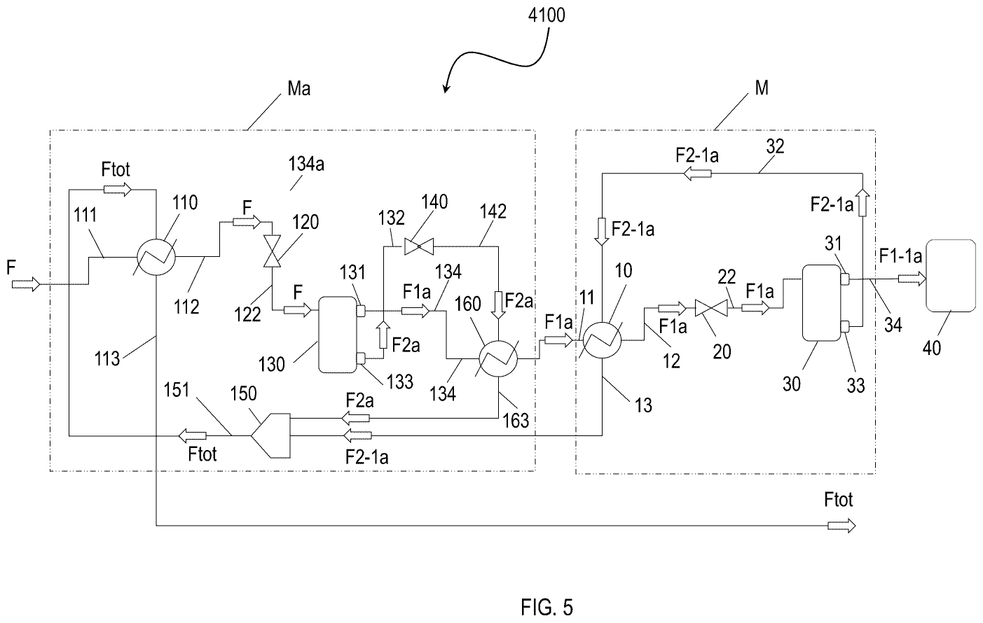

With reference to FIG. 5, a plant for separating hydrogen from natural gas in accordance with a fifth embodiment of the present invention is illustrated therein. This plant differs from the plants 2100 and 3100, described above and illustrated in FIGS. 3 and 4, in that between the hydrogen separation modules M and Ma there are further decompression or expansion means and a further heat exchanger.

The plant, generally indicated by the reference numeral 4100, therefore comprises, analogously to the plants 2100 and 3100, a hydrogen separation module M and an auxiliary hydrogen separation module Ma connected between them in cascade.

The hydrogen separation module M comprises a heat exchanger 10, decompression or expansion means, for example a throttling valve 20, which are placed downstream of the heat exchanger 10 and in fluid communication with the heat exchanger 10 through a first outlet duct 12 of the heat exchanger 10, and a flash separator 30, placed downstream of the decompression means 20 and in fluid communication with the decompression means 20 through an outlet duct 22 of the throttling valve 20.

The flash separator 30 comprises an upper outlet 31, from which an upper outlet duct 34 extends, and a lower outlet 33, from which a lower outlet or recirculation duct 32 extends, which puts the flash separator 30 in fluid communication with the heat exchanger 10 positioned upstream. The heat exchanger 10 further comprises an inlet duct 11 and a second outlet duct 13.

The auxiliary hydrogen separation module Ma comprises, in turn, a heat exchanger 110, decompression or expansion means, in the illustrated example a throttling valve 120 placed downstream of the heat exchanger 110, and a flash separator 130 placed downstream of the throttling valve 120. The throttling valve 120 is in fluid connection with the heat exchanger 110 through a first outlet duct 112 of the heat exchanger 110 and the flash separator 130 is in fluid communication with the throttling valve 120 through an outlet duct 122 of the throttling valve 120.

The flash separator 130 comprises an upper outlet 131, from which an upper outlet duct 134 extends, and a lower outlet 133, from which a lower outlet or recirculation duct 132 extends. The heat exchanger 110 further comprises an inlet duct 111 and a second outlet duct 113.

The plant 4100 further comprises further decompression or expansion means, in the illustrated example a throttling valve 140 placed downstream of the flash separator 130 and in fluid communication with it through the lower outlet duct 132 of the flash separator 130. Downstream of the flash separator 130 and of the throttling valve 140 there is further provided a further heat exchanger 160, which is in fluid communication with the throttling valve 140 through an outlet duct 142 and with the flash separator 130 through the upper outlet duct 134.

The heat exchanger 160 is also in fluid connection with the heat exchanger 10 of the hydrogen separation module M through the inlet duct 11 of the hydrogen separation module M and has an outlet or recirculation duct 163, which puts the further heat exchanger 160 in fluid communication with the upstream heat exchanger 110.

The plant 4100 further comprises a mixer 150, which intercepts the outlet duct 163 and the second outlet duct 13, respectively, of the further heat exchanger 160 of the auxiliary hydrogen separation module Ma and of the heat exchanger of the hydrogen separation module M and is positioned upstream of the heat exchanger 110 of the auxiliary hydrogen separation module Ma and with it in 10 fluid connection through an outlet duct 151.

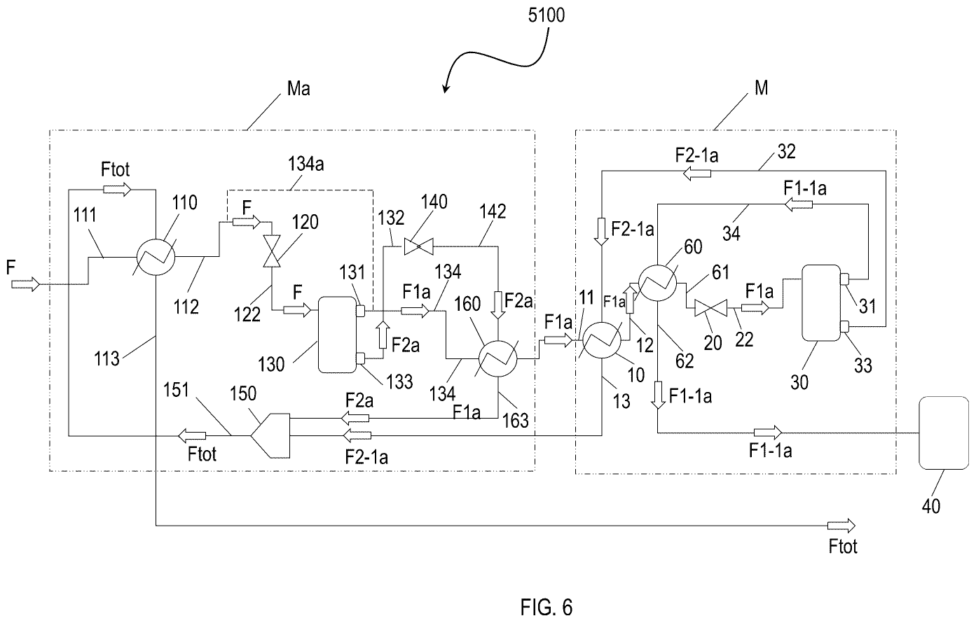

With reference to FIG. 6, a plant therein for separating hydrogen from natural gas in accordance with a sixth embodiment of the present invention is illustrated therein.

The plant, generally indicated with the reference numeral 5100, differs from the plant 4100 of FIG. 5 in that it provides, in the hydrogen separation module M, a further heat exchanger 60 positioned between the heat exchanger 10 and the throttling valve 20. In particular, the heat exchanger 60 is in fluid communication with the heat exchanger 10 through the first outlet duct 12 of the heat exchanger 10 and with the throttling valve 20 through a first outlet duct 61. The heat exchanger 60 is further in fluid communication with the flash separator 30 through the upper outlet duct 34 of the flash separator and further comprises a second outlet duct 62.

With reference to FIG. 5, a process for separating hydrogen that is carried out using the plant 4100 is now described.

When the plant 4100 is in operation, a flow F of natural gas, coming for example from a methane pipeline (not shown) enters the heat exchanger 110 of the auxiliary hydrogen separation module Ma through the inlet duct 111 and exits from the heat exchanger 110 through the first outlet duct 112.

Inside the heat exchanger 110, the flow F of natural gas with excess hydrogen undergoes a pre-cooling and the pre-cooled flow F exiting from the heat exchanger 110 enters the throttling valve 120 through the first outlet duct 112.

Inside the throttling valve 120, the pre-cooled flow F of natural gas with excess hydrogen undergoes a decompression or expansion and exits from the throttling valve 120, further cooled and in the form of a liquid-gas two-phase fluid or a supercritical fluid, through the outlet duct 122. The cooled flow F of natural gas with excess hydrogen exiting from the throttling valve 120 enters the flash separator 130 through the outlet duct 122 of the throttling valve 120.

Inside the flash separator 130, the cooled flow F of natural gas with excess hydrogen is separated into a first flow F1a of hydrogen-rich natural gas and a second flow F2a of hydrogen-poor natural gas. In particular, the first flow F1a of hydrogen-rich natural gas is in the form of a gaseous mixture of natural gas containing the excess hydrogen in a percentage comprised between 45% and 55% and preferably equal to 50%, while the second hydrogen-poor flow F2a is in the form of a liquid mixture of natural gas containing a hydrogen percentage lower than 1-2% and otherwise entirely equivalent to the flow F of natural gas entering the heat exchanger 110 of the auxiliary hydrogen separation module Ma of the plant 2100 through the inlet duct 111.

The first flow F1a of natural gas exits from the upper outlet 131 of the flash separator 130 and is fed to the further heat exchanger 160 through the upper outlet duct 134 of the flash separator 130.

Inside the heat exchanger 160, the flow F1a of natural gas undergoes a further cooling and the cooled flow F1a exiting from the heat exchanger 160 enters the heat exchanger 10 of the hydrogen separation module M of the plant 2100 through the inlet duct 11 of the heat exchanger 10.

Inside the heat exchanger 10, the flow F1a of natural gas is pre-cooled and the pre-cooled flow F1a exiting from the heat exchanger 10 enters the throttling valve 20 through the first outlet duct 12 of the heat exchanger 10.

Inside the throttling valve 20, the pre-cooled flow F1a of natural gas undergoes a decompression or expansion, and exits, further cooled, the throttling valve 20 through the outlet duct 22 in the form of a liquid-gas two-phase fluid or a supercritical fluid.

The cooled flow F1a of natural gas exiting from the throttling valve 20 then enters the flash separator 30 through the outlet duct 22 of the throttling valve 20.

Inside the flash separator 30, the cooled flow F of natural gas is separated into a first flow F1-1a of hydrogen-rich natural gas and a second flow F1-2a of hydrogen-poor natural gas. In particular, the first flow F1-1a of hydrogen-rich natural gas is in the form of a gaseous mixture of natural gas containing the excess hydrogen in a percentage comprised between 81% and 99% and preferably equal to 90%, while the second hydrogen-poor flow F2-1a is in the form of a liquid mixture of natural gas containing a hydrogen percentage lower than 1-2%.

The first flow F1-1a of natural gas exits from the flash separator 30 through the upper outlet 31 and the upper outlet duct 34 and is preferably stored in a pressurized tank 40 or introduced into a distribution network dedicated to industrial users for use, for example, for the production of methane or synthetic hydrocarbons (Sabatier synthesis with use of CO2), or as fuel for some types of fuel cells.

If the further heat exchanger 60 is provided, and therefore the plant 5100 of FIG. 6 is used, the first flow F1-1a of natural gas exiting from the flash separator 30 through the upper outlet 31 is sent, through the upper outlet duct 34, to the heat exchanger 60. Inside the heat exchanger 60, the flow F1a of natural gas with excess hydrogen arriving from the exchanger 10 through the first outlet duct 12 is further cooled and introduced into the throttling valve 20 through the first outlet duct 61 of the heat exchanger 60. The first flow F1-1a exits from the heat exchanger 60 through the second outlet duct 62 and is preferably stored in a pressurized tank 40. As an alternative to storage in the pressurized tank 40, the first flow F1-1a of hydrogen-rich natural gas can be introduced into a distribution network dedicated to industrial users for use, for example, for the production of methane or synthetic hydrocarbons (Sabatier synthesis with use of CO2), or as fuel for some types of fuel cells.

The second flow F2-1a of natural gas exits from the flash separator 30 through the lower outlet 33 of the flash separator 30 and is recirculated in the heat exchanger 10 through the recirculation duct 32. The second flow F2-1a of natural gas, entering the heat exchanger 10 through the recirculation duct 32, acts as a refrigerant fluid of the flow F1a of natural gas with excess hydrogen, entering the heat exchanger 10, and exits from the heat exchanger 10, and from the hydrogen separation module M of the plant 100, through the second outlet duct 13 of the heat exchanger 10 in the form of a gaseous mixture of natural gas with a hydrogen content lower than 1-2%.

The second flow F2a of natural gas exits from the flash separator 130 of the auxiliary hydrogen separation module Ma through the lower outlet 133 and is fed at the entry to the further throttling valve 140 through the lower outlet duct 132 and from the further throttling valve 140 to the further heat exchanger 160 through the outlet duct 142 of the further throttling valve 140. The second flow F2a of natural gas, entering the further heat exchanger 160 acts as a refrigerant fluid of the flow F1a of natural gas entering the further heat exchanger 160 through the upper outlet duct 134 of the flash separator 130 and exits from the heat exchanger 160 through the outlet duct 163, in the form of a gaseous mixture of natural gas with a hydrogen content lower than 1-2%.

The flows F2-1a and F2a of natural gas are mixed together in the mixer 150 and the resulting total flow Ftot is recirculated in the heat exchanger 110 of the auxiliary hydrogen separation module Ma through the outlet duct 151 of the mixer 150.

The total flow Ftot of natural gas entering the heat exchanger 110 acts as a refrigerant fluid of the flow F of natural gas with excess hydrogen, entering the heat exchanger 110 through the inlet duct 111 and exits, heated, the heat exchanger 110, and the auxiliary hydrogen separation module Ma, through the second outlet duct 113 of the heat exchanger 110.

Following the heat exchange which takes place inside the heat exchanger 110, the liquid mixture of natural gas, which constitutes the total flow Ftot of hydrogen-poor natural gas, evaporates and exits from the heat exchanger 110 in the form of a gaseous mixture of natural gas with a hydrogen content lower than 1-2%.

From the above description it is evident how the plant and the process for separating hydrogen from natural gas described above allow to achieve the proposed purposes.

It is finally obvious to a person skilled in the art that it is possible to make changes and variations to the solution described with reference to the figures without departing from the scope of protection of the present invention as defined by the appended claims. For example, although the above-described plants 1100 and 2100 contain only one auxiliary hydrogen separation module Ma, in addition to the hydrogen separation module M, plants comprising multiple auxiliary modules connected in cascade between them fall within the scope of protection of the present invention.

1-15. (canceled)

16. A plant for separating hydrogen from natural gas comprising: a hydrogen separation module, which includes a heat exchanger, decompression means placed downstream of the heat exchanger and in fluid connection with the heat exchanger through a first outlet duct of the heat exchanger, and a flash separator placed downstream of the decompression means and in fluid communication with the decompression means through an outlet duct of the decompression means,
wherein the flash separator is configured to separate a flow of natural gas with a hydrogen content higher than a predetermined threshold, entering the hydrogen separation module through an inlet duct of the heat exchanger, into a first flow of natural gas containing the excess hydrogen and a second flow of natural gas with a hydrogen content below the predetermined threshold,
wherein the flash separator comprises an upper outlet and a lower outlet, from which an outlet or recirculation duct extends, in the heat exchanger, of the second flow of natural gas exiting from the flash separator, for a heat exchange with the flow of natural gas entering the hydrogen separation module,
and wherein the heat exchanger comprises a second outlet duct, from the hydrogen separation module, of the second heated flow of natural gas with a hydrogen content below the predetermined threshold.

17. The plant according to claim 16, further comprising, upstream of the hydrogen separation module, at least one auxiliary hydrogen separation module, which comprises a heat exchanger, decompression means, placed downstream of the heat exchanger and in fluid communication with the heat exchanger through a first outlet duct of the heat exchanger, and a flash separator, placed downstream of the decompression means and in fluid communication with the decompression means through an outlet duct of the decompression means, wherein the flash separator comprises an upper outlet and a lower outlet and is configured to separate a flow of natural gas with a hydrogen content higher than a predetermined threshold, entering the auxiliary hydrogen separation module through the heat exchanger, into a first flow of natural gas containing the excess hydrogen and a second flow of natural gas with a hydrogen content below the predetermined threshold, wherein the upper outlet of the flash separator of the auxiliary hydrogen separation module is in fluid communication with the heat exchanger of the hydrogen separation module placed downstream through the inlet duct of the heat exchanger and wherein the heat exchanger of the hydrogen separation module is in fluid communication with the heat exchanger of the auxiliary hydrogen separation module through its second outlet duct.

18. The plant according to claim 17, wherein the lower outlet of the flash separator is in fluid communication with the heat exchanger of the hydrogen separation module placed downstream through a lower outlet duct of the flash separator.

19. The plant according to claim 18, further comprising a mixer, which intercepts the recirculation duct of the hydrogen separation module and the lower outlet duct of the flash separator of the auxiliary hydrogen separation module and is positioned upstream of the heat exchanger of the hydrogen separation module and with it in fluid connection through an outlet duct of the mixer.

20. The plant according to claim 16, wherein the auxiliary hydrogen separation module further comprises further decompression means and a further heat exchanger placed downstream of the further decompression means and in fluid communication with them through the outlet duct, wherein the further decompression means are in fluid communication with the flash separator of the auxiliary hydrogen separation module through a lower outlet duct of the flash separator and wherein the further heat exchanger is in fluid communication with the flash separator of the auxiliary hydrogen separation module through an upper outlet duct of the flash separator and with the heat exchanger of the hydrogen separation module through the inlet duct of the heat exchanger.

21. The plant according to claim 20, wherein the further heat exchanger comprises an outlet or recirculation duct, which puts the further heat exchanger in fluid communication with the upstream heat exchanger.

22. The plant according to claim 21, further comprising a mixer, which intercepts the outlet duct of the further heat exchanger of the auxiliary hydrogen separation module and the second outlet duct of the heat exchanger of the hydrogen separation module and is positioned upstream of the heat exchanger of the auxiliary hydrogen separation module and with it in fluid connection through an outlet duct of the mixer.

23. The plant according to claim 16, wherein the hydrogen separation module comprises a further heat exchanger, positioned between the heat exchanger and the decompression means, wherein the further heat exchanger is in fluid communication with the heat exchanger through the first outlet duct of the heat exchanger and with the decompression means through a first outlet duct and wherein the further heat exchanger is further in fluid communication with the flash separator through the upper outlet duct of the flash separator and further comprises a second outlet duct.

24. A process for separating hydrogen from natural gas comprising the following steps:
(a) feeding a flow of natural gas at the entry to a heat exchanger of a hydrogen separation module of a hydrogen separation plant, the natural gas having a hydrogen content higher than a predetermined threshold;
(b) pre-cooling the flow of natural gas in the heat exchanger;
(c) cooling, in decompression means, the pre-cooled flow of natural gas exiting from the heat exchanger;
(d) separating, in a flash separator, the cooled flow of natural gas exiting from the decompression means into a first flow of natural gas containing the excess hydrogen and into a second flow of natural gas with a hydrogen content below the predetermined threshold;
(e) recirculating the second flow of natural gas exiting from the flash separator in the heat exchanger, in which it acts as a refrigerant fluid for the flow of natural gas entering the heat exchanger; and
(f) producing at the exit from the heat exchanger the second heated flow of natural gas.

25. A process according to claim 24, further comprising, upstream of the feeding step (a), the following steps:
(a1) feeding a flow of natural gas at the entry to a heat exchanger of an auxiliary hydrogen separation module of the hydrogen separation plant, the natural gas having a hydrogen content higher than a predetermined threshold;
(b1) pre-cooling the flow of natural gas in the heat exchanger;
(c1) cooling, in decompression means, the pre-cooled flow of natural gas exiting from the heat exchanger;
(d1) separating, in a flash separator, the cooled flow of natural gas exiting from the decompression means into a first flow of natural gas containing the excess hydrogen and into a second flow of natural gas with a hydrogen content below the predetermined threshold;
(e1) feeding the first flow of natural gas containing the excess hydrogen of natural gas with a hydrogen content below the predetermined threshold at the entry to the heat exchanger of the hydrogen separation module;
(f1) recirculating a total flow of natural gas with a hydrogen content below the predetermined threshold in the heat exchanger of the auxiliary hydrogen separation module, in which it acts as a refrigerant fluid for the flow of natural gas entering the heat exchanger; and
(g1) producing, at the exit from the heat exchanger of the auxiliary hydrogen separation module, the total heated flow of natural gas with a hydrogen content below the predetermined threshold.

26. The process according to claim 25, wherein the total flow of natural gas with a hydrogen content below the predetermined threshold recirculated in the heat exchanger of the auxiliary hydrogen separation module is obtained by mixing the second flow of natural gas with a hydrogen content below the predetermined threshold exiting from the flash separator of the auxiliary hydrogen separation module and the second flow of natural gas with a hydrogen content below the predetermined threshold exiting from the flash separator of the hydrogen separation module.

27. The process according to claim 26, wherein the step of feeding the first flow of natural gas containing the excess hydrogen at the entry to the heat exchanger of the hydrogen separation module coincides with the feeding step (a).

28. The process according to claim 25, further comprising, downstream of the separation step (d1), the further steps of:
(e2) cooling, in a further heat exchanger of the auxiliary hydrogen separation module, the first flow of natural gas containing the excess hydrogen exiting from the flash separator;
(f2) cooling, in further decompression means of the auxiliary hydrogen separation module, the second flow of natural gas with a hydrogen content below the predetermined threshold exiting from the flash separator;
(g2) feeding the first cooled flow of natural gas containing the excess hydrogen exiting from the further heat exchanger into the heat exchanger of the hydrogen separation module;
(h2) feeding the second cooled flow of natural gas with a hydrogen content below the predetermined threshold at the entry to the further heat exchanger, in which it acts as a refrigerant fluid for the first flow of natural gas containing the excess hydrogen entering the further heat exchanger; and
(i2) recirculating a total flow of natural gas with a hydrogen content below the predetermined threshold in the heat exchanger of the auxiliary hydrogen separation module, in which it acts as a refrigerant fluid for the flow of natural gas entering the heat exchanger, wherein the total flow of natural gas with a hydrogen content below the predetermined threshold is obtained by mixing the second flow of natural gas with a hydrogen content below the predetermined threshold exiting from the further heat exchanger of the auxiliary hydrogen separation module and the second flow of natural gas with a hydrogen content below the predetermined threshold exiting from the heat exchanger of the separation module.

29. The process according to claim 28, wherein the step of feeding (g2), into the heat exchanger of the hydrogen separation module, the cooled flow of natural gas containing the excess hydrogen, exiting from the further heat exchanger, coincides with the feeding step (a).

30. The process according to claim 24, further comprising, downstream of the separation step (d1), the further steps of:
(m1) feeding the first flow of natural gas into a further heat exchanger of the hydrogen separation module, in which it acts as a refrigerant fluid for the flow of natural gas coming from the heat exchanger; and
(n1) feeding, to the decompression means, the first further cooled flow of natural gas exiting from the further heat exchanger.
